(19) United States
(12) Patent Application Publication
(10) Pub. No.: US 2016/0203290 A1
(43) Pub. Date: Jul. 14, 2016

(54) SMART MESSAGING SYSTEM FOR MEDICATION ADHERENCE

(71) Applicant: THE REGENTS OF THE UNIVERSITY OF MICHIGAN, Ann Arbor, MI (US)

(72) Inventors: Lawrence C. An, Ann Arbor, MI (US); John Piette, Ann Arbor, MI (US); Satinder Singh, Ann Arbor, MI (US); Karen Farris, Ann Arbor, MI (US)

(21) Appl. No.: 14/976,429

(22) Filed: Dec. 21, 2015

Related U.S. Application Data
(60) Provisional application No. 62/101,770, filed on Jan. 9, 2015.

(51) Int. Cl. G06F 19/00; H04L 12/58

(52) U.S. Cl. CPC G06F 19/3456; G06F 19/3418; H04L 51/24

(57) ABSTRACT

A method and system may provide automated messages to a patient to increase the likelihood that the patient adheres to a medication regimen. A reinforcement learning engine determines the patient's barriers to adherence and transmits messages generated to address those barriers. The reinforcement learning engine constantly receives feedback from the patient and adjusts the messages that are transmitted to the patient, for example, when the patient's barrier to adherence changes, when the patient incorrectly identifies his barrier to adherence, and/or when the patient becomes desensitized to receiving the same message over and over again.

### CROSS-REFERENCE TO RELATED APPLICATION

This application claims the benefit of U.S. Provisional Application No. 62/101,770, filed Jan. 9, 2015, entitled “Smart Messaging System for Medication Adherence,” which is hereby incorporated by reference in its entirety.

### TECHNICAL FIELD

The present disclosure generally relates to methods for sending messages to patients to improve adherence to medication regimens and, more particularly, to utilizing reinforcement learning techniques to continuously adjust messages sent to a patient to address the patient's specific and long-term issues with medication adherence.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many patients fail to successfully adhere to medication therapy regimens. Poor medication adherence can interfere with the ability to treat many diseases, leading to greater complications from the illness and a lower quality of life for patients. Additionally, patients who don't take their medication often end up with more expensive complications, contributing to escalating costs to the health care system at an estimated rate of $290 billion annually, according to “Thinking Outside The Pillbox: A System-wide Approach to Improving Patient Adherence for Chronic Disease,” by the New England Healthcare Institute, 2009. Studies have shown that in addition to forgetfulness, reasons for non-adherence include patients' beliefs in the severity of their illnesses and the effectiveness of their medications, according to “Frequency of and reasons for medication non-fulfillment and non-persistence among American adults with chronic disease in 2008,” by McHorney Calif., 2011.

To date, few have proposed effective techniques for providing medication adherence messages to patients, and those that have been proposed do not provide messages based on real-time information corresponding to the types of messages which are most effective for a particular patient.

### SUMMARY

To improve the likelihood in which a patient adheres to a medication therapy regimen (the patient's adherence rate), a reinforcement learning system receives baseline information from the patient regarding reasons for non-adherence. For example, the patient may report that she does not believe the disease is serious enough to warrant taking medication, that she does not believe her medication is effective in treating the disease, that the side effects for the medication are too harmful, that she forgets to take her medication, that the medication is too costly, etc. The system may then determine a baseline adherence rate based on the baseline information, and transmit one or several communication message to the patient. For example, if the patient indicates she does not believe her medication is effective, the system may transmit daily messages to the patient explaining the benefits of the medication and the medication's ability to fight and cure the patient's illness. Upon receiving the messages, the patient may transmit adherence information to the reinforcement learning system. The adherence information may include self-reported information from the patient including whether or not the patient took the prescribed medication and/or how often the patient took the prescribed medication since receiving the messages. In other examples, the adherence information may be obtained from a fully or partially automated process. For the latter, for example, the adherence information may include sensor data obtained from a pill bottle opening sensor that records how often the patient opened the pill bottle for the prescribed medication. In some examples, the automatically obtained adherence information may be combined with self-reporting adherence information. The adherence information may further include any other data corresponding to the frequency in which the patient took the prescribed medication, whether obtained automatically or otherwise, and whether obtained continuously or periodically, or in real time, and/or from historically-recorded data.

The reinforcement learning system may then determine a measured adherence rate from the adherence information, and compare the measured adherence rate to the baseline adherence rate for the patient to determine whether the patient's medication adherence level is heading in the desired direction, for increasing when the patient's adherence is below a prescribed regimen.

The system is automatically, self-adapting. If medication adherence increases, the reinforcement learning system may continue to transmit the same messages to the patient and determine whether the measured adherence rate continues to increase. The reinforcement learning system may also determine whether the patient begins to experience message fatigue from receiving the same message repeatedly. Otherwise, if the measured adherence rate remains the same or decreases from the baseline adherence rate, the reinforcement learning system may try sending a different message to the patient and may determine whether the different message increases medication adherence. For example, the system may send a different type of communication (e.g., the communication may change from a communication addressing the importance of the disease to a communication addressing the effectiveness of the medication), may send the communication at a different time of day, may send a different mode of communication (e.g., the communication may change from a short message service (SMS) text message to an email or automated voice message), or may alter/adjust the message in any other suitable manner.

In this manner, the system may adapt or “learn” a patient's reasons for non-adherence, even if the patient's self-reported reasons are inaccurate or the patient's reasons change over time. While computing devices are typically designed to follow a set of instructions from the time in which the instructions are programmed, the set of instructions may not account for changing needs of patients over time. By utilizing reinforcement learning techniques, the present embodiments may advantageously tailor adherence messages to individual patient requirements which may change over time. The system may continuously adjust the adherence message transmitted to the patient to improve the patient's long-term medication adherence. This is particularly important because a patient's specific reasons for non-adherence may change over time related to life circumstances, new experiences with specific medications, or exposure to new information from family, friends, or the media.

Additionally, the present embodiments may advantageously improve adherence rates, increasing quality of life for the patients and decreasing complications as a result of corresponding diseases and the number of hospital visits for the patients. Moreover, by receiving real-time adherence information on a regular basis, such as daily, weekly, etc., the present embodiments advantageously adapt quickly to address changes to a patient's barriers to adherence further improving adherence rates. As opposed to receiving adherence information at doctor's visits which may occur monthly, semi-annually, or annually, the present embodiments allow for the reinforcement learning system to receive adherence information on a daily basis.

In one embodiment, a computer-implemented method for increasing medication adherence for a patient using reinforcement learning is provided. The method includes receiving a first indication of patient medication adherence for a patient, the first indication of medication adherence being electronic data indicating one or more barriers to a patient's adherence to a medication regimen, determining one or more medication adherence message characteristics for transmitting a medication adherence message to the patient based on the first indication of medication adherence, and transmitting, to the patient, an automated communication message based on the one or more medication adherence message characteristics. The method further includes receiving a second indication of patient medication adherence for the patient, the second indication of medication adherence being electronic data indicating a patient's adherence to the medication regimen at a point in time different than that of the first indication of medication adherence, adjusting the one or more medication adherence message characteristics based on the second indication of medication adherence and the transmitted communication message where the one or more processors adjusts the one or more medication adherence message characteristics via a reinforcement learning engine to autonomously learn barriers to adherence and to improve a medication adherence rate for the patient, and transmitting, to the patient, an automated adjusted communication message based on the one or more adjusted medication adherence message characteristics.

In another embodiment, a computer device for increasing medication adherence for a patient using reinforcement learning includes a communication network, one or more processors and one or more non-transitory memories coupled to the communication network and the one or more processors, wherein the one or more memories include computer-executable instructions stored therein that, when executed by the one or more processors, cause the one or more processors to: receive, via the communication network, first indication of medication adherence for a patient, the first indication of medication adherence being electronic data indicating one or more barriers to a patient's adherence to a medication regimen. Further, the computer-executable instructions cause the one or more processors to determine one or more medication adherence message characteristics for transmitting a medication adherence message to the patient based on the first indication of medication adherence, transmit, to the patient, an automated communication message based on the one or more medication adherence message characteristics, and receive a second indication of medication adherence for the patient, the second indication of medication adherence being electronic data indicating a patient's adherence to the medication regimen at a point in time different than that of the first indication of medication adherence. Still further, the computer-executable instructions cause the one or more processors to adjust the one or more medication adherence message characteristics based on the second indication of medication adherence and the transmitted communication message, where the one or more processors adjusts the one or more medication adherence message characteristics via a reinforcement learning engine to autonomously learn barriers to adherence and to improve a medication adherence rate for the patient, and transmit, to the patient, an automated adjusted communication based on the one or more adjusted medication adherence message characteristics.

### BRIEF DESCRIPTION OF THE DRAWINGS

FIG. 1 illustrates a block diagram of an example communication system in which techniques for medication adherence messaging are implemented;

FIG. 2 illustrates a block diagram of an example reinforcement learning feedback loop;

FIG. 3 illustrates an example medication adherence message content table in accordance with the presently described embodiments;

FIGS. 4A-4C illustrate example results comparing adherence rates for various adherence techniques;

FIG. 5A illustrates a flow diagram of an example method for increasing medication adherence using reinforcement learning techniques; and

FIG. 5B illustrates a flow diagram of an example method of block 516 of FIG. 5A.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

Generally speaking, techniques for medication adherence messaging may be implemented in one or more network-enabled devices, one or more network servers, or a system that includes a combination of these devices. However, for example purposes, the examples below focus primarily on an embodiment in which data indicative of a patient's adherence to a medication regimen is generated on a network-enabled device. For example, the patient may self-report the data on a laptop computer, a desktop computer, a smart phone, a network-enabled cell phone, a wearable computing device, etc. Alternatively, the medication adherence data may be obtained automatically, for example, from a wired or wireless communication between a server device and an electronic pill bottle opening sensor at a patient's home or care facility. In any event, the obtained medication adherence data may then be communicated to a network server such as an adherence messaging server. The adherence messaging server may adaptively generate a communication message to send to the patient based on the medication adherence data, and may transmit the communication message to one of the patient's network-enabled devices depending on the mode of communication in which the network server transmits the message.

In an example scenario, John Doe suffers from a chronic illness that requires a daily medication regimen. He claims that he fails to take his medication regularly because he is forgetful and because the medication does nothing to alleviate his symptoms. As a result, the medication adherence messaging system transmits messages to John Doe's smart phone with tips for remembering to take medication regularly and messages that include facts about the effectiveness of the medication. The system may receive adherence information about John's adherence to the regimen and analyze that information, e.g., by comparing it to other existing adherence information from John, from the overall population, from a predetermined population subset characteristic of John's profile (e.g., from a population subset where each member is similar in age, of the same gender, has a similar health condition and/or takes a similar medication as John), from a population subset characteristic of John's profile which is learned by the adherence messaging server, etc. From this automated comparison, the system may be recognize, from the adherence information, John is no longer forgetful about taking his mediation but still remains skeptical about the effects of the medication. Based on this discovery, the system may exclusively transmit messages related to the effectiveness of the medication, and may also go a few days without sending messages so John does not tire of receiving the same message. As a result, John Doe receives messages catered to address his specific barriers to adherence without receiving an overflow of the same type of messages. In this way, not only is the system able to tailor messages to John, but the messages are tailored based on a determined reasoning for John's lack of adherence to the prescribed treatment regimen.

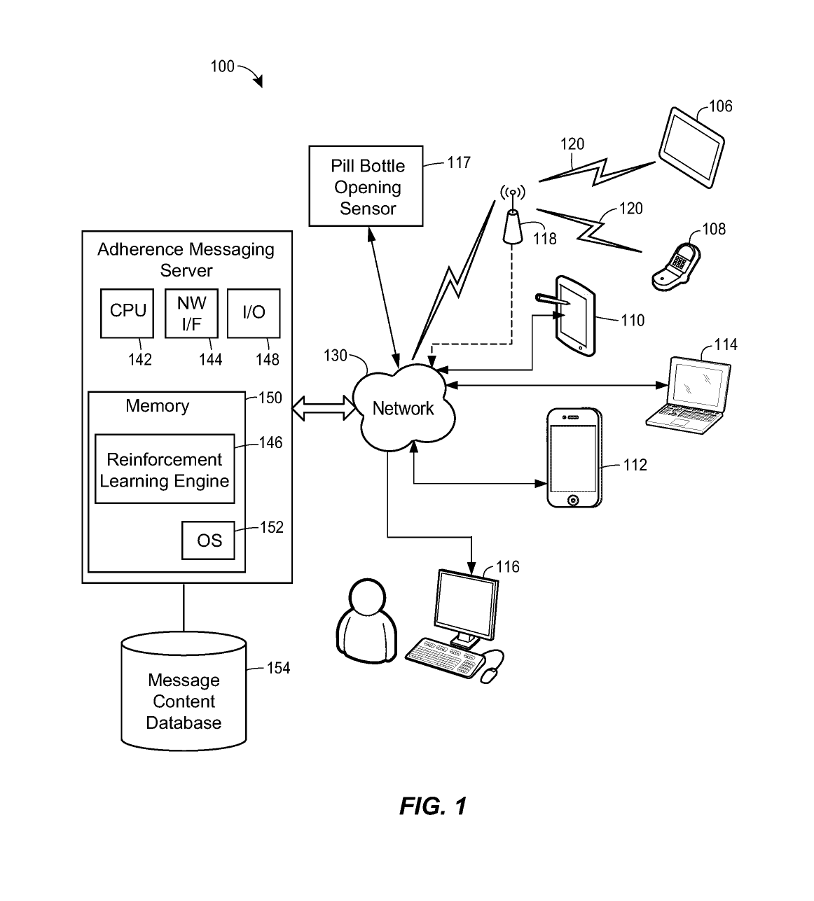

Referring to FIG. 1, an example communication system 100 in which the techniques outlined above can be implemented includes an adherence messaging server 140, and one or more network-enabled devices 106-117. In an embodiment, the adherence messaging server 140 and the one or more network-enabled devices 106-117 may communicate via wireless signals 120 over a communication network 130, which can be any suitable local or wide area network(s) including a Wi-Fi network, a Bluetooth network, a cellular network such as 3G, 4G, Long-Term Evolution (LTE), the Internet, etc. In some instances, the network-enabled devices 106-117 may communicate with the communication network 130 via an intervening wireless or wired device 118, which may be a wireless router, a wireless repeater, a base transceiver station of a mobile telephony provider, etc. The network-enabled devices 106-117 may include, by way of example, a tablet computer 106, a network-enabled cell phone 108, a personal digital assistant (PDA) 110, a mobile device smart-phone 112 also referred to herein as a “mobile device,” a laptop computer 114, a desktop computer 116, a pill bottle opening sensor 117 such as a Medication Event Monitoring System (MEMS®) cap, a portable media player (not shown), a wearable computing device such as Google Glass™ (not shown), etc. Moreover, any other suitable network-enabled device that records medication adherence data or is capable of receiving communication messages may also communicate with the adherence messaging server 140. For example, the communication system 100 may also include network-enabled devices which record the number of capsules remaining in a pill container, the number of days between requesting medication refills, the number of times a user ingests a capsule, etc.

Each of the network-enabled devices 106-117 may interact with the adherence messaging server 140 to transmit medication adherence data and/or to receive medication adherence messages. In an example implementation, the adherence messaging server 140 may be a cloud based server, an application server, a web server, etc., and includes a memory 150, one or more processors (CPU) 142, a network interface unit 144, and an I/O module 148.

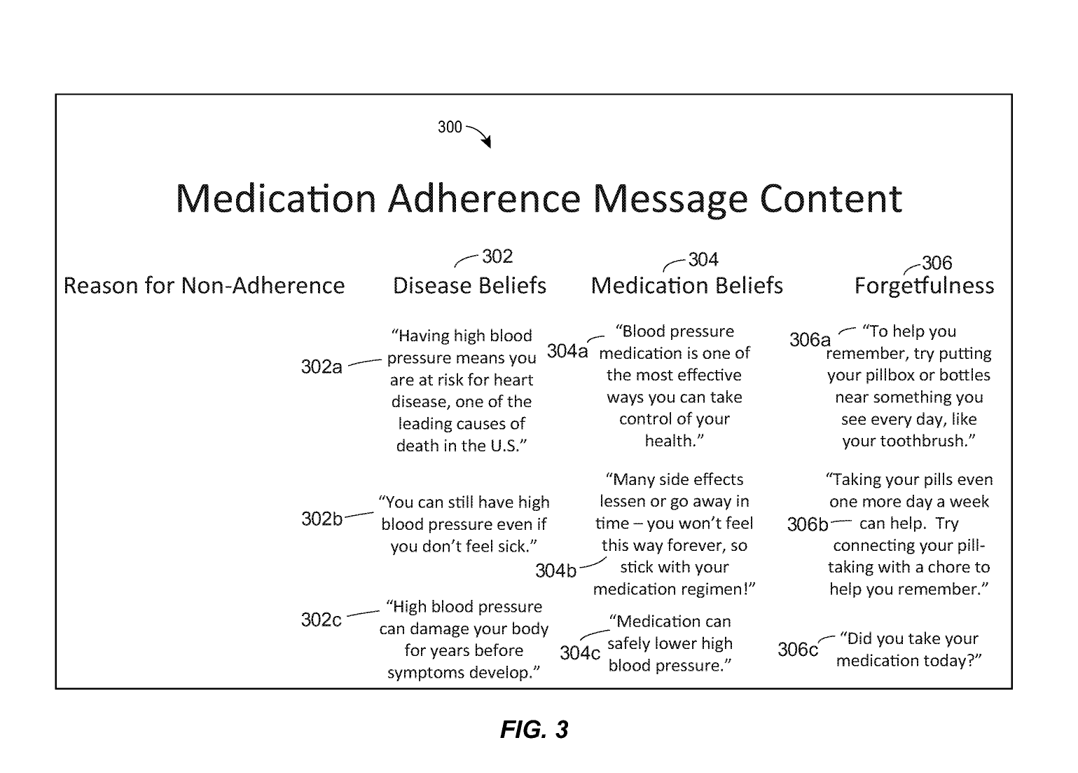

The server 140 is also communicatively connected to a message content database 154. The message content database 154 may include one or more types of communication messages corresponding to barriers to medication adherence and may include several different communication messages for each type. For example, for communication messages corresponding to forgetfulness, the message content database 154 may include the message content, “Did you take your medication today?” Example message content is discussed further below with reference to FIG. 3.

The memory 150 may be tangible, non-transitory memory and may include any types of suitable memory modules, including random access memory (RAM), read only memory (ROM), flash memory, other types of persistent memory, etc. The memory 150 stores an operating system (OS) 152 and one or more modules including a reinforcement learning engine 146. The operating system 152 may be any type of suitable operating system such as modern smartphone operating systems, for example. Also, the I/O module 148 may be a keyboard or a touchscreen, for example.

The reinforcement learning engine 146 may receive electronic medication adherence data from a network-enabled device. For example, a patient may self-report barriers to medication adherence on her laptop computer which may be transmitted to the server 140. The reinforcement learning engine 146 may then estimate a baseline likelihood of adherence based on the self-reported barriers, for example, by determining the probability of taking medication for a patient population having one of the self-reported barriers, and aggregating/combining/multiplying the probabilities for each of the self-reported barriers. Moreover, a communication message including one or several medication adherence message characteristics may be generated and transmitted to one of the patient's network-enabled devices.

Message characteristics may include: (1) a particular message type selected from several message types which address various barriers to medication adherence, (2) a mode of communication, and (3) timing information. For example, a communication message to address disease beliefs may be transmitted to the patient every evening via email. In some embodiments, the communication message to address disease beliefs may be generated when the patient reports disease beliefs as a barrier to adherence, and the probability of taking medication is lowest, as compared to probabilities for the patient's other reported barriers, for a patient population whose reasons for non-adherence are based on disease beliefs.

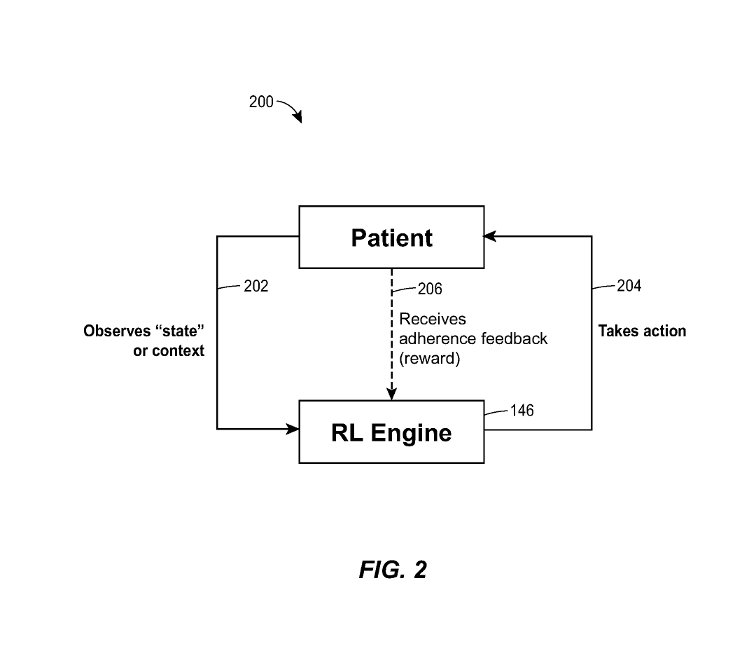

The reinforcement learning engine 146 may then continuously adjust the communication message based on additional electronic medication adherence data received from the patient. For example, the reinforcement learning engine 146 may calculate an average and standard deviation of the patient's adherence rate for each message characteristic or combination of message characteristics (e.g., the patient's average adherence rate when receiving communication messages via email may be 75%). The reinforcement learning engine 146 may then transmit communication messages having message characteristics which correspond to the highest aggregate average and standard deviation adherence rate. In some embodiments, the reinforcement learning engine 146 may transmit an alert or notification to a healthcare professional or member of a healthcare team, who may then contact the patient. The alert or notification may be transmitted when the patient's adherence rate does not increase or does not reach a specified threshold in response to the adjusted electronic communication messages sent to the patient. The reinforcement learning engine 146 is discussed in further detail below with reference to FIG. 2.

The adherence messaging server 140 may also include a server application (not shown) for transmitting web pages or application screens to the one or more network-enabled devices. In some embodiments, the server application may also interact with patients via interactive voice response (IVR) in an automated phone call. The web pages or application screens may include user controls for patients to select reasons for non-adherence, to assign values to each of the reasons for non-adherence, and/or to enter free form text explaining reasons for non-adherence. Moreover, via IVR, patients may select reasons for non-adherence from a predetermined list of reasons (e.g., the automated phone call may instruct the patient to dial ‘1’ for forgetfulness, ‘2’ for harmful side effects, etc.), assign values to each of the reasons for non-adherence, and/or may vocally enter reasons for non-adherence. Patients may self-report their barriers to adherence via the web pages, application screens, or IVR transmitted by the server 140, and these barriers may be transmitted to the reinforcement learning engine 146 via the communication network 130.

It will be understood that although the server 140 is illustrated in FIG. 1 as a single device, in general the server 140 can correspond to multiple servers responsible for respective types of content or respective operations. For example, a first server may collect, and analyze medication adherence data from one or more patients. Additionally, a second server may transmit a communication message specific to each patient to the patient's network-enabled device.

FIG. 2 illustrates a block diagram of a reinforcement learning feedback loop 200 which includes the reinforcement learning engine 146 of FIG. 1. To determine which messages are most effective in improving a patient's adherence to a medication regimen, the reinforcement learning engine 146 constantly receives feedback in the form of medication adherence data from the patient and adjusts the transmitted message accordingly.

For example, the reinforcement learning engine 146 may determine a baseline adherence rate for the patient. In some embodiments, the baseline adherence rate may be determined by self-reported barriers to adherence from the patient. For example, the patient may report, via the network-enabled devices 106-117, that she forgets to take the medication, that she does not believe the disease is serious enough to warrant constant medication, that she does not believe that the medication helps fight the disease, that she does not like the side effects from the medication, etc.

The reinforcement learning engine 146 may then calculate an estimated baseline adherence rate based on the patient's reported barriers. For example, the estimated baseline adherence rate may be calculated as P_{(adherence)}=P_{(disease)}*P_{(medication)}*P_{(remembering)}, where P_{(disease)} is the extent to which the patient believes that the disease is serious, P_{(medication)} is the extent to which the patient believe that the medication is effective, and P_{(remembering)} is the extent to which the patient remembers to take the medication. Each extent may range in values from 0 to 1, corresponding to a probability that the patient takes the medication due to each respective barrier. The patient may report the value, for example, 0.75, or may merely report that the respective barrier is an issue for the patient. The reinforcement learning engine 146 may then calculate the value based on statistical data of medication adherence rates for patients reporting the same barrier. For example, the reinforcement learning engine 146 may determine P_{(medication)} is 0.65 for patients who report medication beliefs as a barrier to medication adherence (i.e., the probability of taking medication is 65% for this patient population), and 1 (i.e., 100% adherence probability) for patients who do not report medication beliefs as a barrier to medication adherence. The baseline adherence rate and/or an adherence rate for each measured combination of message characteristics may be referred to as state or context for the patient 202.

In some embodiments, the baseline adherence rate may be determined based on demographic characteristics for the patient. For example, young males may be unlikely to believe their illnesses are severe enough to warrant taking daily medication. Therefore, the reinforcement learning engine 146 may determine a low P_{(disease)} for all young males. In this manner, certain aspects of the baseline adherence rate can be generalized for all patients within the same demographic. Moreover, the baseline adherence rate may be determined based on previous medication adherence information for the patient (e.g., from previous medications prescribed to the patient), or any other determinant of self-care behavior.

The reinforcement learning engine 146 may then take action 204 by generating a communication message having one or more medication adherence message characteristics based on the baseline adherence rate. Message characteristics may include a particular type of communication message. For example, if the patient reports medication beliefs as her only barrier to adherence, the reinforcement learning engine 146 may generate communication messages having message content which addresses the patient's medication beliefs. Moreover, message characteristics may also include timing information for the communication messages, including the time of day for transmitting the message, and/or the frequency in which the communication messages are sent, may include a mode of communication for sending the communication messages, and/or any other suitable message characteristics. For example, the communication messages may be sent via SMS text message, email, automated voice message, phone call, push notification, etc. Once the message characteristics are determined, the reinforcement learning engine 146 may transmit the communication message to the patient via one of the network-enabled devices 106-117.

In some embodiments, the reinforcement learning engine 146 may generate a probability distribution for sending the communication messages to the patient based on the baseline adherence rate. For example, if the patient reports medication beliefs as her only barrier to adherence, the reinforcement learning engine 146 may generate communication messages having message content which addresses the patient's medication beliefs 60 percent of the time, message content which addresses the patient's disease beliefs 20 percent of the time, message content which addresses the patient's forgetfulness 10 percent of the time, and no message 10 percent of the time. In this manner, the reinforcement learning engine 146 can test the effects of each message type on the patient's adherence, while transmitting the message type that is the most likely to increase adherence most frequently.

The reinforcement learning engine 146 may include a module for analyzing such adherence data and determining probability distributions for taking future actions to affect that adherence data. The future actions would depend on the application of use. For example, in the example of increasing patient medication regimen adherence using messages, the future actions would depend on (i) timing, i.e., the timing of message information provided to the patient, (ii) mode of communication, i.e., the mode by which message information is provided to a patient, and (iii) content, i.e., the content of the message information delivered. That is, the reinforcement learning engine 146, applying adaptive learning processes, may generate a probability distribution for the timing information and another probability distribution for the mode of communication. In other examples, the reinforcement learning engine 146 may generate a single probability distribution including a combination of message characteristics. For example, of the communication messages having message content which addresses the patient medication beliefs, 70 percent may be sent to the patient via SMS text, 20 percent via email, and 10 percent via automated voice recording. In some embodiments, the communication messages may be transmitted to the patient once each day. The messages will be automatically transmitted by the system 140 to the network-enabled devices 106-117 through network 130 and using the communication mode pathway through the network 130 that corresponds to the communication mode determined, by the reinforcement learning engine, to be the mode of the next message.

In response to the communication messages, one or more network-enabled devices 106-117 may transmit feedback indicating the patient's current adherence rate 206, which may also be referred to as a reward. For example, the pill bottle opening sensor 117 may transmit an indication to the reinforcement learning engine 146 each time the pill bottle is opened or is supposed to be opened based on how often the patient is directed to take the corresponding medication (e.g., once a day, twice a day, three times a day, etc.). Alternatively or additionally, the patient may self-report her adherence rate after a predetermined amount of time (e.g., every day, several times per day, every week, every month, etc.) via a web page, application screen, or IVR. For example, the patient's adherence rate may be 70 percent after receiving message content which addresses medication beliefs, 30 percent after receiving message content which addresses disease beliefs and 20 percent after receiving message content which addresses forgetfulness. In other embodiments, the reinforcement learning engine 146 may receive feedback indicative of several days, weeks, or months of information in “batches.” For example, the patient may complete a self-report, once a week, indicating whether he took his medication each day that week and/or the amount of times per day he took his medication. Additionally, the pill bottle opening sensor 117 may transmit an indication including the amount of times a pill bottle corresponding to the patient's medication was opened over several days, weeks, or months. The reinforcement learning engine 146 may then compare the feedback with the communication messages to determine which message characteristics have been the most effective in increasing the patient's adherence rate.

In some embodiments, the reinforcement learning engine 146 may include a module that predicts future adherence rates for each combination of message characteristics based on a regression analysis and/or recent trends. The future adherence rates may be compared with the baseline adherence rate to determine whether to continue transmitting the same communication message or to generate a new communication message having different message characteristics. In this manner, the reinforcement learning engine 146 may take into account the long term effects of sending communication message with a particular message characteristic or combination of message characteristics.

The reinforcement learning engine 146 may then adjust the message characteristics or the probability distribution of message characteristics based on the feedback. In the example above, the reinforcement learning engine 146 transmits messages to address medication beliefs most frequently, and the patient's adherence rate is the highest after receiving this type of message. As a result, the reinforcement learning engine 146 may continue to transmit messages to address medication beliefs until the messages are no longer as effective on the patient. While messages to address medication beliefs may be transmitted most frequently, messages to address other barriers to non-adherence may also be transmitted to the patient, though such messages may be transmitted a smaller percentage of the time than the messages to address medication beliefs. When messages to address medication beliefs become less effective on the patient, the reinforcement learning engine 146 may once again adjust the message characteristics or the probability distribution of message characteristics, so that messages to address other barriers to non-adherence are transmitted more frequently. In this way, the effectiveness of one type of message (e.g., messages to address medication beliefs) may be affected by another type of otherwise unrelated message (e.g., messages to address other barriers to non-adherence).

In addition to adjusting the type of communication message, the reinforcement learning engine 146 may adjust the timing information and/or mode of communication for transmitting the communication message. For example, the patient may take her medication 80 percent of the time after receiving the message between 5 and 7 p.m., and 10 percent of the time after receiving the message during any other time of day. As a result, the reinforcement learning engine 146 may transmit communication messages to the patient solely (or at least a vast majority of the time) between 5 and 7 p.m.

In some embodiments, the reinforcement learning engine 146 may use upper-confidence-bounds for adjusting the message characteristics in the transmitted communication message. For example, the reinforcement learning engine 146 may calculate a mean adherence rate (μ_{adherence}) and a standard deviation (σ_{adherence}) for each message characteristic or combination of message characteristics which were transmitted in a communication message to the patient. The reinforcement learning engine 146 may then select a communication message with the message characteristics having the highest aggregate mean and standard deviation adherence rate (μ_{adherence}+σ_{adherence}). In other embodiments, the reinforcement learning engine 146 may adjust the message characteristics in the transmitted communication message using any other suitable reinforcement learning techniques.

In some examples, the communication message is adjusted constantly based on the patient's most recent feedback. For example, the reinforcement learning engine 146 may determine that transmitting messages to address forgetfulness is the most effective in increasing the patient's medication adherence. However, over time the patient may become less forgetful but begin to have doubts in the severity of the disease. Based on a constant feedback approach, the reinforcement learning engine 146 may determine that messages to address forgetfulness no longer improve the patient's adherence rate, and instead messages to address disease beliefs are more effective. That is, the reinforcement engine is able to determine message type fatigue and then determine a different message type to then automatically send to the patient, e.g., changing from a message directed to increase regimen adherence when the patient has waned because of one rationale, to a message directed to increase regimen adherence by directing the message to a different rationale. For example, the reinforcement learning engine 146 may adjust the probability distribution so that messages to address disease beliefs are transmitted to the patient more frequently than messages to address forgetfulness.

The communication message may also be adjusted to factor in message fatigue. Even when the reinforcement learning engine 146 determines the most effective message to increase medication adherence for the patient, the message may lose its effect if it is sent too often. As a result, the reinforcement learning engine 146 may determine that in some instances not sending a message may be the best option. For example, if after sending several messages to address forgetfulness, the patient's adherence rate declines but messages to address other barriers do not have much of an effect on the patient, the reinforcement learning engine 146 may not send a message for a day or a few days. Then, the reinforcement learning engine 146 may once again send messages to address forgetfulness. If this technique increases the patient's adherence rate, the reinforcement learning engine 146 may “learn” that after sending a particular amount of the same type of messages, the patient suffers message fatigue and it is therefore beneficial not to send a message for a short period of time before repeating a sequence of the same type of message.

In some embodiments, in addition and/or as an alternative to an adjusted communication message, the reinforcement learning engine 146 may transmit an alert or notification to a healthcare professional or member of a healthcare team, who may then contact the patient. The alert or notification may be transmitted when the patient's adherence rate does not increase or does not reach a specified threshold in response to the electronic communication messages sent to the patient.

When a type of communication message is selected, the reinforcement learning engine 146 selects the message content specific to the patient's disease from the message content database 154 of FIG. 1. For each type of communication message, i.e., what type of low adherence rationale is the patient exhibiting (e.g., disease beliefs, medication beliefs, forgetfulness, etc.), there may be any number of messages having different message content. FIG. 3 illustrates an example medication adherence message content table 300 which includes example message content for each type of communication message. In some embodiments, the message content table 300 may be stored in the message content database 154.

The message content table 300 may include several entries for each barrier to adherence. For example, the message content table 300 includes entries to address patients' disease beliefs 302, medication beliefs 304, and forgetfulness 306, all related to high blood pressure. Additionally, the message content table 300 may include entries to address any other barriers to adherence such as the cost of the medication, etc. Moreover, while the message content table 300 includes three entries for each barrier to adherence, this is for ease of illustration only. The message content table 300 may include any suitable number of entries, and there may be hundreds or thousands of entries for each barrier to adherence. Furthermore, while the message content table 300 is specific to messages related to high blood pressure, the message content table 300 may include messages related to any type of disease. Additionally or alternatively, there may be several other message content tables that each include messages related to a different type of disease.

In any event, the message content table 300 includes three different messages 302a-c for the disease beliefs barrier, three messages 304a-c for the medication beliefs barrier, and three messages 306a-c for the forgetfulness barrier. The messages for the disease beliefs barrier include: “Having high blood pressure means you are at risk for heart disease, one of the leading causes of death in the U.S.,” (reference 302a), “You can still have high blood pressure even if you don't feel sick,” (reference 302b), and “High blood pressure can damage your body for years before symptoms develop,” (reference 302c). Each of these messages is designed to explain the importance of taking medication for high blood pressure in a slightly different manner.

The first disease belief message 302a addresses the severity of the disease, while the second and third disease belief messages 302b-c explain that the disease is still harmful to the patient even without recognizable symptoms. In this manner, the medication adherence messaging system 100 may address several different beliefs by patients even within the same category of disease beliefs. In some embodiments, the reinforcement learning engine 146 may select message content based on its effect on the patient. For example, the third disease belief message 302c may have the greatest effect on a patient who believes high blood pressure is harmless because he has not exhibited any symptoms. In other embodiments, the reinforcement learning engine 146 may randomly select message content for a particular type of message, may select message content based on how recently each message was transmitted to the patient, or may select message content in any other suitable manner.

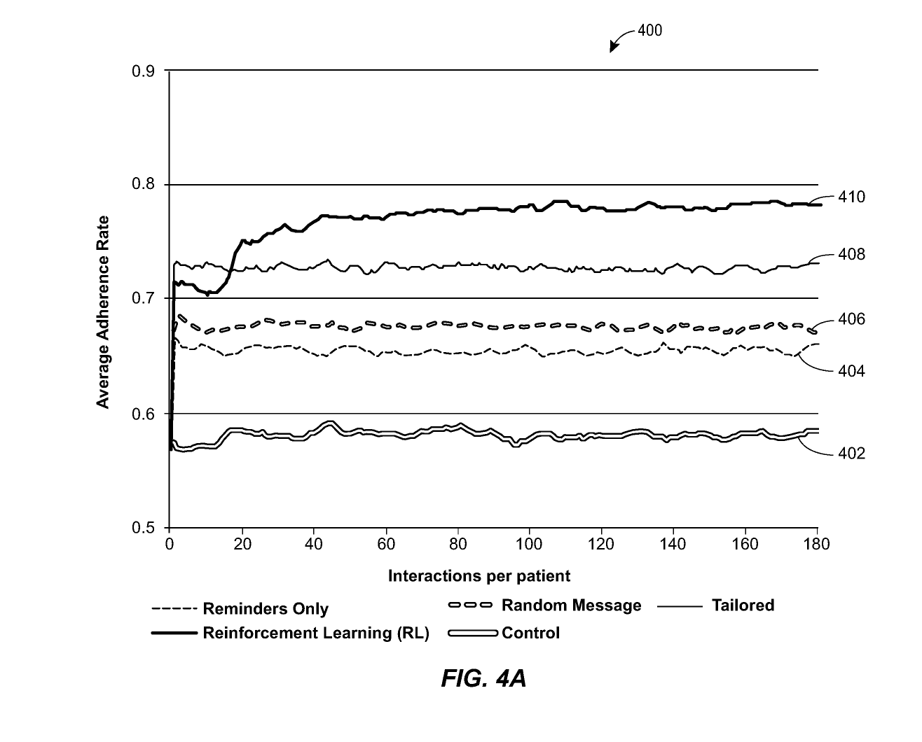

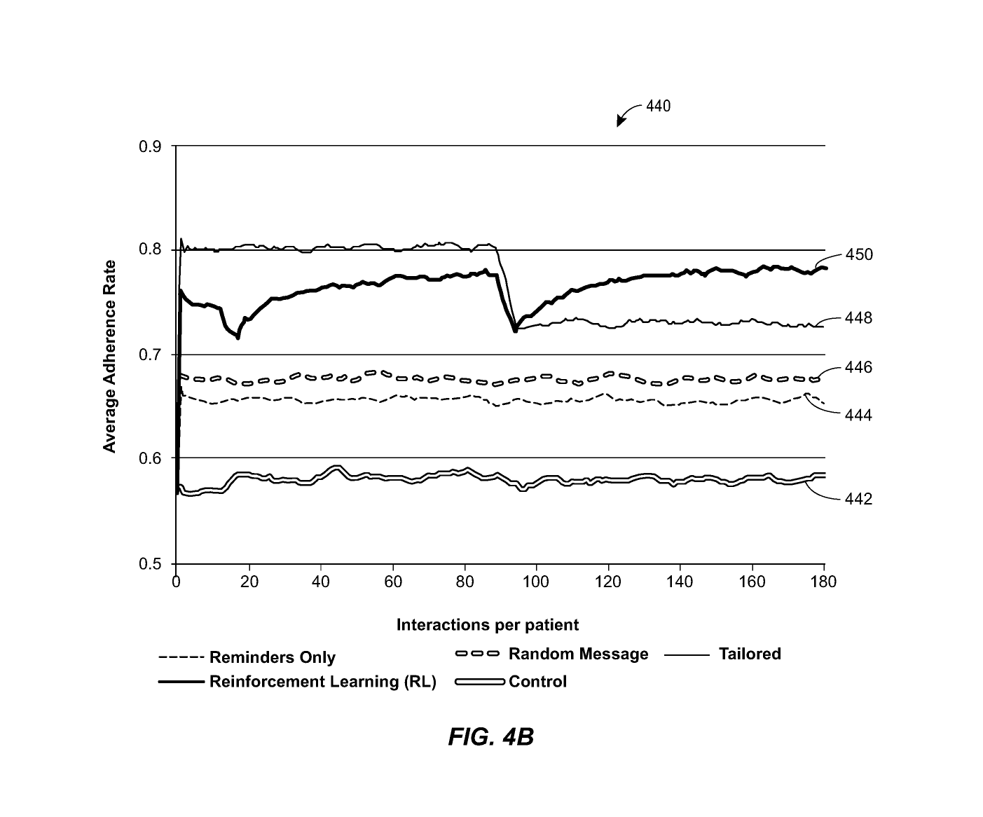

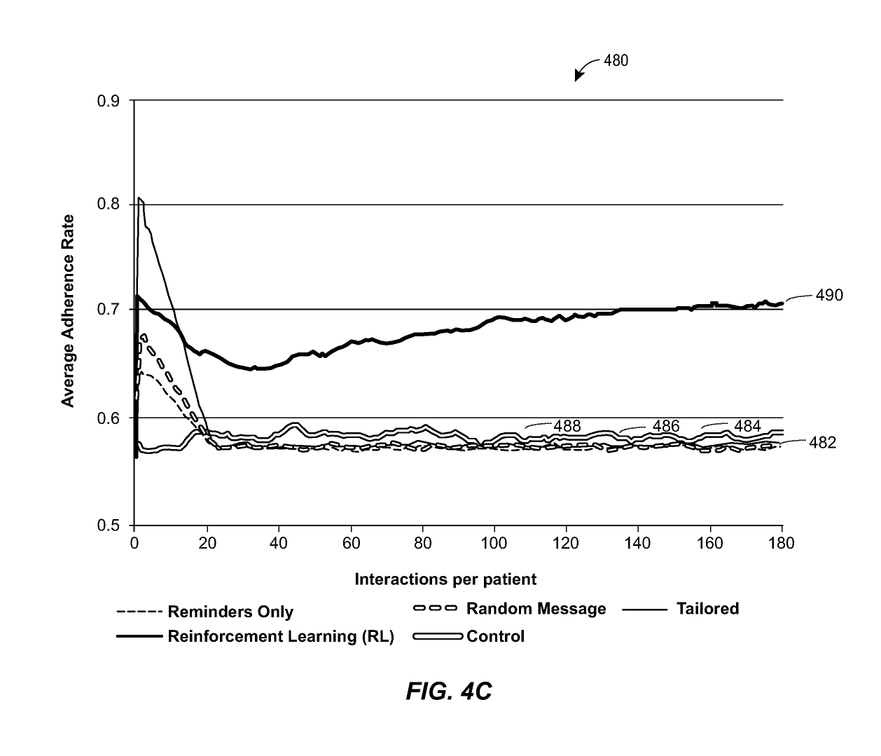

FIGS. 4A-C illustrate example average adherence rates for three example scenarios. In the first example scenario corresponding to the adherence rate graph 400 of FIG. 4A, one-third of the patients do not accurately self-report their barriers to adherence. In the second example scenario corresponding to the adherence rate graph 440 of FIG. 4B, one-third of the patients change their barrier to adherence 90 days after self-reporting baseline adherence. In the third example scenario corresponding to the adherence rate graph 480 of FIG. 4C, the patients experience message fatigue after receiving the same type of message too frequently. In each of the example scenarios, each patient receives a communication message once daily for 180 days. Moreover, in each scenario the adherence rates are determined for five methods of transmitting communication messages: (1) messages generated by the reinforcement learning engine, (2) reminder messages only, (3) messaging addressing each of the potential barriers to adherence but sent randomly, (4) messages tailored to the patients' baseline adherence rates based on self-reporting, and (5) a control where no messages are sent to the patients.

Turning now to FIG. 4A, average adherence rates 400 are illustrated for an example patient population which includes one-third of patients who inaccurately report their barriers to adherence. When it comes to medication adherence, patients inaccurately report their barriers to adherence for a variety of reasons. Patients may not know their actual barriers, may not want to admit their barriers, etc. As a result, it is important for the messaging system to adjust the message characteristics for communication messages sent to patients who inaccurately report their barriers to adherence.

In this example scenario, the average adherence rate for the control patients who receive no message 402 maintain a constant average adherence rate of about 0.57 throughout the entire 180 day period. Moreover, the patients who receive reminders only 404, random messages 406, and tailored messages 408 also maintain constant average adherence rates of about 0.66, 0.67, and 0.73 respectively. The average adherence rates remain constant, because the message characteristics for the messages transmitted to the patients remain the same throughout the 180-day period. Also, the patients' barriers to adherence remain the same so the messages have about the same effect on the patients.

By contrast, for about the first twenty days, the patients who receive messages generated by the reinforcement learning engine 410 have lower average adherence rates than patients who receive tailored messages 408. This may be because two-thirds of the patients who receive tailored messages 408, receive messages which accurately address their barriers to adherence. On the other hand, the reinforcement learning engine may transmit communication messages based on a probability distribution where only a portion of the two-thirds of patients receive messages which accurately address their barriers to adherence. After about ten days, the reinforcement learning engine “learns” the barriers to adherence for the patients who accurately reported their barriers as well as the patients who did not accurately report their barriers to adherence. As a result, the average adherence rate for patients who receive reinforcement learning messages 410 surpasses the average adherence rate for patients who receive tailored messages 408 in about twenty days. The average adherence rate for patients who receive reinforcement learning messages 410 then levels off on about day 40 at an average adherence rate of about 0.78, which is above the average adherence rates for the other four methods.

In the second example scenario as illustrated by the average adherence rates 440 of FIG. 4B, one-third of the patients change their barriers to adherence after 90 days. Patients' need for health information may change over time as they master skills or develop new concerns. Therefore, it is also important for the messaging system to adjust the message characteristics for messages transmitted to patients based on their constantly changing needs.

In the second example scenario, the average adherence rates for patients who receive no message 442, patients who receive reminders only 444, and patients who receive random messages 446 are about the same as in the first example scenario of FIG. 4A. For the patients who receive tailored messages 448, the average adherence rate remains constant at about 0.8 for the first 90 days. Then when one-third of the patients change their barriers to adherence on the 90^{th} day, the average adherence rate decreases dramatically and levels off at about 0.73 from about day 95 until the end of the 180 day period. This is because for the first 90 days the tailored messages accurately address each of the patients' barrier to adherence. When the patients' barriers to adherence change for one-third of the patients, the tailored messages are only accurate for two-thirds of the patients, leading to a dramatic decrease in the effect the tailored messages have on the average adherence rate. As a result, the average adherence rate for patients receiving tailored messages 408, 448 is about the same in FIGS. 4A and 4B at the end of the 180 day period.

Moreover, in the second example scenario, the average adherence rate for patients who receive reinforcement learning messages 450 initially decreases for about the first ten days while the reinforcement learning engine “learns” the patients' barriers to adherence. The average adherence rate then steadily increases until day 90 when there is a dramatic decrease due to the one-third of the patients who change their barriers to adherence, e.g., their reasons for non-adherence to the regimen. However, unlike the patients who receive tailored messages 448, the average adherence rate for patients who receive reinforcement learning messages 450 slowly increases as the reinforcement learning engine “learns” the patient's barriers to adherence for the third of patients who changed their barriers. By the end of the 180-day period the average adherence rate for patients who receive reinforcement learning messages 450 is about 0.78 or about the same as it was at day 90 when the one-third of patients changed their barriers to adherence.

In the third example scenario as illustrated by the average adherence rates 480 of FIG. 4C, the patients begin to experience message fatigue. Over time patients become desensitized when receiving the same communication message, and the messaging system may need to recognize when the messages begin to lose their effect on patients and adjust the message characteristics accordingly.

In the third example scenario, the average adherence rates for patients who receive reminders only 484, patients who receive random messages 486, and patients who receive tailored messages 488 each plummet to the control adherence rate of about 0.57. This may be because over time the effect of the messages on the patients decreases due to message fatigue until the messages have essentially zero effect on the patients' adherence rates. By contrast, the average adherence rate for patients who receive reinforcement learning messages 490 decreases until about day 30. During this time period, the reinforcement learning engine “learns” that the patients are fatigued and the appropriate response is not to send a message to the patient for a short time period (e.g., a few days). The reinforcement learning engine may also optimize the number of days in which a message should not be sent to each patient. After the first 30 days, the average adherence rate for patients who receive reinforcement learning messages 490 slowly increases and then levels off at a constant adherence rate of about 0.70 by the end of the 180-day period. In this manner, the reinforcement learning engine may continue to keep patients' adherence rate above their baseline adherence rate even when they begin to suffer from message fatigue. The reinforcement learning engine therefore allows for long-term improvement of patients' adherence to medication regimens rather than a short term increase in adherence followed by a regression to the baseline rates.

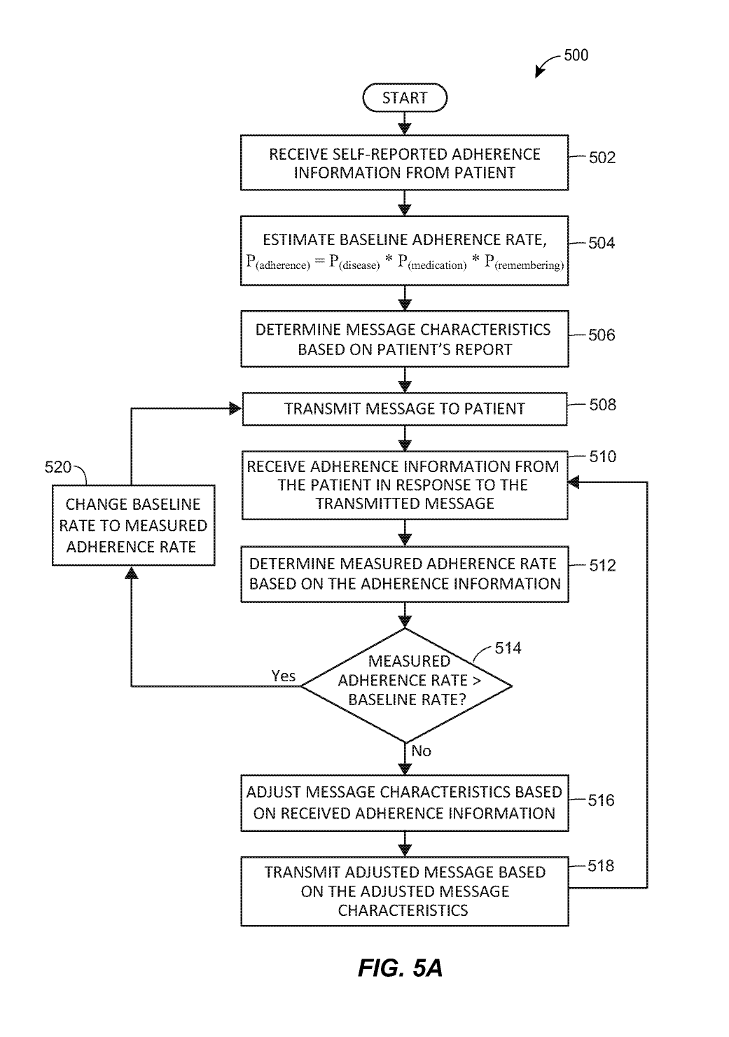

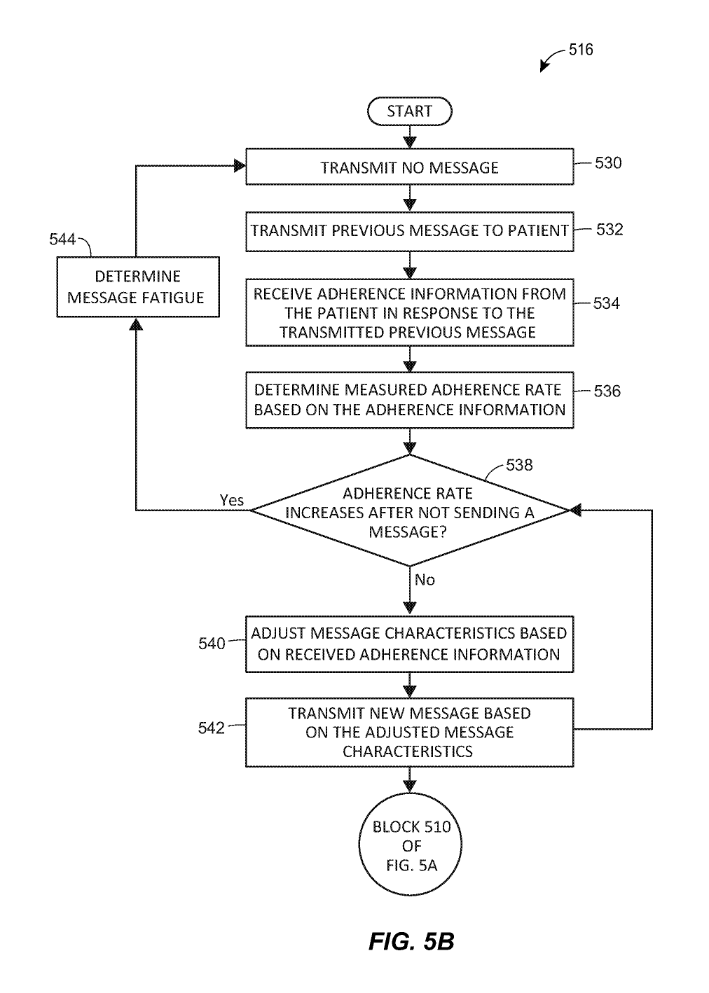

FIG. 5A illustrates a flow diagram of an example method 500 for increasing medication adherence using reinforcement learning techniques. The method 500 may be executed on the adherence messaging server 140 of FIG. 1, one or more network-enabled device 106-117, or some combination of the adherence messaging server 140 and the one or more network-enabled devices 106-117. For example, at least a portion of the method 500 may be performed by the reinforcement learning engine 146 which may be disposed within the adherence messaging server 140. In an embodiment, the reinforcement learning engine 146 may include computer-executable instructions stored on one or more non-transitory, tangible, computer-readable storage media or device, and the computer-executable instructions of the reinforcement learning engine 146 may be executed to perform the method 500.

At block 502, the reinforcement learning engine 146 receives self-reported adherence information from a patient for determining a baseline adherence rate. For example, the patient may generate electronic data indicating one or more barriers to adherence on a web page, application screen, or via IVR, which may be transmitted to the reinforcement learning engine 146 via the communication network 130. The web page or application screen may include several user controls for selecting barriers to adherence such as forgetfulness, disease beliefs, medication beliefs, etc., and/or the patient may select the extent to which she remembers to take her medication, believes the disease is serious, or believes the medication is effective (e.g., from a scale of 0 to 1). In some embodiments, the patient's disease may also be received so that the reinforcement learning engine 146 can generate communication messages specific to the patient's disease type.

In any event, the reinforcement learning engine 146 may estimate a likelihood that the patient adheres to his medication regimen as a baseline adherence rate (block 504). As mentioned above, the baseline adherence rate may be determined based on the self-reported adherence information from the patient. For example, the baseline adherence rate may be determined as P_{(adherence)}=P_{(disease)}*P_{(medication)}*P_{(remembering)}, where P_{(disease)} is the extent to which the patient believes that the disease is serious, P_{(medication)} is the extent to which the patient believes that the medication is effective, and P_{(remembering)} is the extent to which the patient remembers to take the medication.

In other embodiments, the reinforcement learning engine 146 may determine the baseline adherence rate based on previous information for the patient from other medications, or may determine the baseline adherence rate based on average adherence rates for patients of the same demographic as the patient. For example, if the patient is a young male his adherence rate may be lower than a middle aged female, and he may be less likely to believe his illness is severe enough to warrant taking daily medication. Moreover, a teenager may be more likely to respond to communication messages transmitted via push notification on an application screen than an older person. In yet other embodiments, the baseline adherence rate may be determined based on previous medication adherence information for the patient (e.g., from previous medications prescribed to the patient), or any other determinant of self-care behavior.

At block 506, medication adherence message characteristics are determined based on the baseline adherence rate. For example, if the patient self-reports that her disease beliefs are the biggest barrier to adherence, the communication message characteristics may include a type of communication message to address disease beliefs. Moreover, in some embodiments, the reinforcement learning engine 146 may determine a probability distribution for transmitting each communication message having a different combination of message characteristics. For example, the reinforcement learning engine 146 may determine that messages generated to address disease beliefs, sent between 2 and 6 p.m. via SMS text message should be transmitted 5 percent of the time.

The reinforcement learning engine 146 may then transmit automated communication messages to the patient according to the communication message characteristics (block 508). In some embodiments, the reinforcement learning engine 146 may retrieve message content from the message content database 154 specific to the patient's disease. For example, the reinforcement learning engine may randomly select one of the messages to address disease beliefs from the message content database 154. Also, in some embodiments, communication messages may be transmitted to the patient daily or in accordance with the patient's medication regimen (e.g., if the patient is prescribed medication to be taken twice a day, communication messages may be transmitted twice each day). The communication messages may be transmitted to one or more network-enabled device 106-117 of the patient depending on the selected mode of communication. For example, SMS text messages may be sent to the patient's smart phone 112, whereas emails may be sent to the patient's laptop computer 114.

At block 510, the reinforcement learning engine 146 may receive adherence information indicating measured adherence rates in response to the transmitted communication messages. For example, the patient may self-report whether and/or how many times he took his medication each day, which may be compared to the transmitted communication message for the particular day. Alternatively, the pill bottle opening sensor 117 may transmit an indication each day (or each time the pill bottle should have been opened, e.g., twice a day if the patient is directed to take her medication twice each day) of whether the pill bottle corresponding to the patient's medication was opened. Moreover, other network-enabled devices may transmit the number of capsules remaining in a pill container, the number of days between requesting medication refills, the number of times a user ingests the capsule, etc. In other embodiments, the reinforcement learning engine 146 may receive adherence information indicating measured adherence rates over several days, weeks, or months in “batches.” For example, the patient may complete a self-report, once a week indicating whether he took his medication each day that week and/or the amount of times per day he took his medication. Additionally, the pill bottle opening sensor 117 may transmit an indication every month of the amount of times that the pill bottle corresponding to the patient's medication was opened.

In any event, a measured adherence rate may be determined based on the adherence information (block 512). The measured adherence rate may be an overall adherence rate indicating the probability that the patient adheres to a medication regimen over a given time interval. Additionally, the measured adherence rate may include separate adherence rates for each message characteristic or combination of message characteristics. Moreover, in some embodiments, the reinforcement learning engine 146 may predict future adherence rates for each message characteristic or combination of message characteristics based on a regression analysis and/or recent trends. The future adherence rates may be compared with the baseline adherence rate to determine whether to continue transmitting the same communication.

In other embodiments, the reinforcement learning engine 146 may calculate a mean adherence rate (μ_{adherence}) and a standard deviation (σ_{adherence}) for each message characteristic or combination of message characteristics which were transmitted in a communication message to the patient.

The reinforcement learning engine 146 may determine the effectiveness of the communication message by comparing the measured adherence rate to the baseline rate (block 514). If the measured adherence rate is greater than the baseline adherence rate, the reinforcement learning engine 146 may change the baseline adherence rate to the measured adherence rate and repeat blocks 508-514. In this manner, the reinforcement learning engine 146 constantly compares adherence information received from the patient to the previous adherence rate to determine whether the adherence rate or predicted future adherence rate continues to improve, decline or remain the same.

If the measured adherence rate is not greater than the baseline adherence rate, the reinforcement learning engine 146 adjusts the communication message characteristics based on the adherence information (block 516). For example, if initially the reinforcement learning engine 146 transmitted communication messages to address forgetfulness 60 percent of the time, to address disease beliefs 30 percent of the time, to address medication beliefs 5 percent of the time, and no message 5 percent of the time, the reinforcement learning engine 146 may adjust the probability distribution. If the adherence rate only increased from the baseline adherence rate when the patient received disease belief messages, the probability distribution may be adjusted such that the reinforcement learning engine transmits communication messages to address forgetfulness 20 percent of the time, to address disease beliefs 60 percent of the time, to address medication beliefs 15 percent of the time, and no message 5 percent of the time. In other embodiments, the reinforcement learning engine 146 may transmit the communication message having message characteristics with the highest aggregate mean and standard deviation adherence rate (μ_{adherence}+σ_{adherence}).

The reinforcement learning engine 146 may then transmit automated adjusted communication messages to the patient according to the adjusted communication message characteristics, and repeat blocks 510-518. In some embodiments, in addition or as an alternative to an adjusted communication message, the reinforcement learning engine 146 may transmit an alert or notification to a healthcare professional or member of a healthcare team, who may then contact the patient. The alert or notification may be transmitted when the patient's adherence rate does not increase or does not reach a specified threshold in response to the electronic communication messages sent to the patient.

FIG. 5B illustrates a flow diagram of an example method of block 516 of FIG. 5A. In this example scenario, the adherence information received at block 510 does not indicate any communication message that increases the adherence rate. As a result, at block 530 the reinforcement learning engine 146 determines not to transmit a message. For example, the engine 146 may determine not to transmit a message for one day, two days, a week, etc. Additionally, the reinforcement learning engine 146 may not transmit a message for a percentage of the time interval in which the communication messages are typically transmitted. For example, if communication messages are being transmitted daily, the reinforcement learning engine may not transmit a message three out of every five days, while transmitting communication messages addressing barriers to non-adherence the other two out of every five days.

At block 532, the reinforcement learning engine 146 transmits the previous message transmitted at block 508 to the patient. In some embodiments, the reinforcement learning engine 146 may transmit communication messages using the same probability distribution as determined at block 506. In any event, the reinforcement learning engine 146 may receive adherence information indicating measured adherence rates in response to the transmitted previous communication messages (block 534).

A measured adherence rate may be determined based on the adherence information (block 536). The measured adherence rate may be an overall adherence rate indicating the probability that the patient adheres to the medication regimen over a given time interval. Additionally, the measured adherence rate may include separate adherence rates for each message characteristic or combination of message characteristics. Moreover, in some embodiments, the reinforcement learning engine 146 may predict future adherence rates for each message characteristic or combination of message characteristics based on a regression analysis and/or recent trends. The future adherence rates may be compared with the baseline adherence rate to determine whether to continue transmitting the same communication. The reinforcement learning engine 146 may determine the effectiveness of sending the previous communication message after not sending a message for a few days by comparing the measured adherence rate for the previous communication to the adherence rate determined at block 512 (block 538). If the measured adherence rate is greater than the adherence rate determined at block 512, the reinforcement learning engine 146 may determine that the patient suffers from message fatigue and repeat blocks 530-536.

If the measured adherence rate is not greater than the adherence rate determined at block 512, the reinforcement learning engine 146 adjusts the communication message characteristics based on the adherence information (block 540). The reinforcement learning engine 146 may then transmit adjusted communication messages to the patient according to the adjusted communication message characteristics, and repeat blocks 510-518 of FIG. 5A.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as providing examples only and does not describe every possible embodiment, as describing every possible embodiment would be impractical, if not impossible. One could implement numerous alternate embodiments, using either current technology or technology developed after the filing date of this application.

We claim:

1. A computer-implemented method for increasing medication adherence for a patient using reinforcement learning, the method comprising:
receiving, at one or more processors, a first indication of medication adherence for a patient, the first indication of medication adherence being electronic data indicating one or more barriers to a patient's adherence to a medication regimen;
determining, by the one or more processors, one or more medication adherence message characteristics for transmitting a medication adherence message to the patient based on the first indication of medication adherence;
transmitting, by the one or more processors and to the patient, an automated communication message based on the one or more medication adherence message characteristics;
receiving, at the one or more processors, a second indication of medication adherence for the patient, the second indication of medication adherence being electronic data indicating a patient's adherence to the medication regimen at a point in time different than that of the first indication of medication adherence;
adjusting, by the one or more processors, the one or more medication adherence message characteristics based on the second indication of medication adherence and the transmitted communication message, wherein the one or more processors adjusts the one or more medication adherence message characteristics via a reinforcement learning engine to autonomously learn barriers to adherence and to improve a medication adherence rate for the patient; and
transmitting, by the one or more processors and to the patient, an automated adjusted communication message based on the one or more adjusted medication adherence message characteristics.

2. The computer-implemented method of claim 1, wherein the one or more medication adherence message characteristics includes at least one of:
a type of communication message selected from a plurality of communication message types, each communication message type generated to address one of the barriers to medication adherence,
a mode of communication for transmitting the communication message, and/or
timing information for transmitting the communication message.

3. The computer-implemented method of claim 2, wherein the type of communication message includes at least one of: a communication message related to an importance of treating a disease corresponding to the medication regimen, a communication message related to a value of taking a prescribed medication corresponding to the medication regimen, a communication message related to remembering to take the prescribed medication, or no communication message.

4. The computer-implemented method of claim 2, wherein a mode of communication includes at least one of: a short message service (SMS) message, an email, a push notification, an automated voice message, or a phone call.

5. The computer-implemented method of claim 2, wherein the one or more medication adherence message characteristics includes the type of communication message selected from the plurality of communication message types, and wherein adjusting the one or more medication adherence message characteristics based on the second indication of patient medication adherence comprises:
determining, by the one or more processors, a first likelihood that the patient adheres to the medication regimen based on the first indication of medication adherence;
determining, by the one or more processors, a second likelihood that the patient adheres to the medication regimen based on the second indication of medication adherence; and
when the second likelihood is not greater than the first likelihood, selecting, by the one or more processors and for the adjusted communication message, a new type of communication message from the plurality of communication message types.

6. The computer-implemented method of claim 5, wherein when the second likelihood is greater than the first likelihood, retaining the type of communication message, and further comprising:
receiving, at the one or more processors, a third indication of patient medication adherence for the patient;
determining, by the one or more processors, a third likelihood that the patient adheres to the medication regimen based on the third indication of patient medication adherence;
when the third likelihood is less than the second likelihood, determining, by the one or more processors, that the patient is experiencing message fatigue;
not transmitting the communication message to the patient over at least a first portion of a time interval in which the communication messages are sent; and
transmitting, by the one or more processors, the new type of communication message from the plurality of communication message types over at least a second portion of the time interval in which the communication messages are sent.

7. The computer-implemented method of claim 5, wherein when the received one or more barriers to adherence for the patient is inaccurate, the method comprises:
transmitting, by the one or more processors and to the patient, the communication message including the type of communication message generated to address the inaccurate barrier to adherence;
determining, by the one or more processors, that the second likelihood is not greater than the first likelihood; and
selecting, by the one or more processors, a type of communication message generated to address an accurate barrier to adherence for the patient.

8. The computer-implemented method of claim 5, wherein when the received one or more barriers to adherence for the patient changes from an old barrier to adherence to a new barrier to adherence, the method comprises:
transmitting, by the one or more processors and to the patient, the adjusted communication message including the type of communication message generated to address the old barrier to adherence;
receiving, at the one or more processors, a third indication of patient medication adherence for the patient;
determining, by the one or more processors, a third likelihood that the patient adheres to the medication regimen based on the third indication of patient medication adherence;
determining, by the one or more processors, that the third likelihood is less than the second likelihood; and
selecting, by the one or more processors, a type of communication message generated to address the new barrier to adherence for the patient.

9. The computer-implemented method of claim 5, wherein receiving a first indication of patient medication adherence includes receiving, by the one or more processors, (i) an extent to which the patient believes a disease corresponding to the medication regimen is important to treat, (ii) an extent to which the patent believes a prescribed medication corresponding to the medication regimen is effective, and (iii) an extent to which the patient remembers to take the prescribed medication; and
wherein the first likelihood that the patient adheres to a medication regimen is determined based on the product of (i) the extent to which the patient believes the disease is important to treat, (ii) the extent to which the patent believes in the prescribed medication is effective, and (iii) the extent to which the patient remembers to take the prescribed medication.

10. The computer-implemented method of claim 1, wherein the second indication of patient medication adherence includes at least one of: self-reported data by the patient corresponding to a number of times that the patient takes a prescribed medication corresponding to the medication regimen, or sensor data corresponding to a number of times that a pill bottle for the prescribed medication is opened.

11. The computer-implemented method of claim 1, wherein the one or more medication adherence message characteristics are determined based on a plurality of indications of medication adherence for a plurality of patients within a same demographic as the patient.

12. A computer device for increasing medication adherence for a patient using reinforcement learning, the computer device comprising:
a communication network,
one or more processors; and
one or more non-transitory memories coupled to the communication network and the one or more processors, wherein the one or more memories include computer-executable instructions stored therein that, when executed by the one or more processors, cause the one or more processors to:
receive, via the communication network, a first indication of medication adherence for a patient, the first indication of medication adherence being electronic data indicating one or more barriers to a patient's adherence to a medication regimen,
determine one or more medication adherence message characteristics for transmitting a medication adherence message to the patient based on the first indication of medication adherence,
transmit, via the communication network and to the patient, an automated communication message based on the one or more medication adherence message characteristics,
receive a second indication of medication adherence for the patient, the second indication of medication adherence being electronic data indicating a patient's adherence to the medication regimen at a point in time different than that of the first indication of medication adherence,
adjust the one or more medication adherence message characteristics based on the second indication of medication adherence and the transmitted communication message, wherein the one or more processors adjusts the one or more medication adherence message characteristics via a reinforcement learning engine to autonomously learn barriers to adherence and to improve a medication adherence rate for the patient, and
transmit, via the communication network and to the patient, an automated adjusted communication based on the one or more adjusted medication adherence message characteristics.

13. The computer device of claim 12, wherein the one or more medication adherence message characteristics includes at least one of:
a type of communication message selected from a plurality of communication message types, each communication message type generated to address one of the barriers to medication adherence,
a mode of communication for transmitting the communication message, and/or
timing information for transmitting the communication message.

14. The computer device of claim 13, wherein the type of communication message includes at least one of: a communication message related to an importance of treating a disease corresponding to the medication regimen, a communication message related to a value of taking a prescribed medication corresponding to the medication regimen, a communication message related to remembering to take the prescribed medication, or no communication message.

15. The computer device of claim 13, wherein a mode of communication includes at least one of: a short message service (SMS) message, an email, a push notification, an automated voice message, or a phone call.

16. The computer device of claim 13, wherein the one or more medication adherence message characteristics includes the type of communication selected from the plurality of communication types, and wherein to adjust the one or more medication adherence message characteristics based on the second indication of patient medication adherence, instructions cause the one or more processors to:
determine a first likelihood that the patient adheres to the medication regimen based on the first indication of patient medication adherence,
determine a second likelihood that the patient adheres to the medication regimen based on the second indication of patient medication adherence, and
when the second likelihood is not greater than the first likelihood, select, for the adjusted communication message, a new type of communication message from the plurality of communication message types.

17. The computer device of claim 16, wherein when the second likelihood is greater than the first likelihood, the instructions cause the one or more processors to retain the type of communication message, and the instructions further cause the one or more processors to:
receive, over the communication network, a third indication of patient medication adherence for the patient,
determine a third likelihood that the patient adheres to the medication regimen based on the third indication of patient medication adherence,
when the third likelihood is less than the second likelihood, determine that the patient is experiencing message fatigue,
not transmit the communication message to the patient over at least a first portion of a time interval in which the communication messages are sent, and
transmit the new type of communication message from the plurality of communication message types over at least a second portion of the time interval in which the communication messages are sent.

18. The computer device of claim 16, wherein to receive a first indication of patient medication adherence the instructions cause the one or more processors to receive, via the communication network, (i) an extent to which the patient believes a disease corresponding to the medication regimen is important to treat, (ii) an extent to which the patent believes a prescribed medication corresponding to the medication regimen is effective, and (iii) an extent to which the patient remembers to take the prescribed medication; and
wherein the first likelihood that the patient adheres to a medication regimen is determined based on the product of (i) the extent to which the patient believes the disease is important to treat, (ii) the extent to which the patent believes the prescribed medication is effective, and (iii) the extent to which the patient remembers to take the prescribed medication.

19. The computer device of claim 12, wherein the second indication of patient medication adherence includes at least one of: self-reported data by the patient corresponding to a number of times that the patient takes a prescribed medication corresponding to the medication regimen, or sensor data corresponding to a number of times that a pill bottle for the prescribed medication is opened.

20. The computer device of claim 12, wherein the one or more medication adherence message characteristics are determined based on a plurality of indications of medication adherence for a plurality of patients within a same demographic as the patient.
